(19) United States
(12) Patent Application Publication
(10) Pub. No.: US 2025/0323293 A1
(43) Pub. Date: Oct. 16, 2025

(54) FUEL CELL SYSTEM

(71) Applicant: TOYOTA JIDOSHA KABUSHIKI KAISHA, Toyota-shi (JP)

(72) Inventors: Tomohiro OGAWA, Miyoshi-shi (JP); Kotaro Maeda, Toyota-shi (JP); Takaoki Ogawa, Toyota-shi (JP); Tomohito Enoki, Toyota-shi (JP); Shinnosuke Sako, Toyota-shi (JP)

(73) Assignee: TOYOTA JIDOSHA KABUSHIKI KAISHA, Toyota-shi (JP)

(21) Appl. No.: 19/000,730

(22) Filed: Dec. 24, 2024

(30) Foreign Application Priority Data
Apr. 16, 2024 (JP) 2024-066335

(51) Int. Cl. H01M 8/04302; H01M 8/04029; H01M 8/04701; H01M 8/04746; H01M 8/04858; H01M 8/249; H01M 16/00

(52) U.S. Cl. CPC H01M 8/04302; H01M 8/04029; H01M 8/04731; H01M 8/04768; H01M 8/0494; H01M 8/04947; H01M 8/249; H01M 16/006

(57) ABSTRACT

The fuel cell system includes a first fuel cell stack, a second fuel cell stack, a first cooling system that causes a refrigerant to flow through the first fuel cell stack, a second cooling system that causes the refrigerant to flow through the second fuel cell stack, and a heat transfer system that allows the refrigerant to flow between the first cooling system and the second cooling system and to shut off the refrigerant.

### CROSS-REFERENCE TO RELATED APPLICATION

This application claims priority to Japanese Patent Application No. 2024-066335 filed on Apr. 16, 2024, incorporated herein by reference in its entirety.

### BACKGROUND

### 1. Technical Field

A fuel cell system is disclosed herein.

### 2. Description of Related Art

The fuel cell system may include a plurality of fuel cell stacks connected to a battery. For example, when the fuel cell system is started, one stack may be started by electric power from the battery, and another stack may be started after the one stack has been started (Japanese Unexamined Patent Application Publication No. 2022-117829 (JP 2022-117829 A)).

### SUMMARY

When a plurality of stacks is provided, the power consumption for starting the stacks tends to increase even if the stacks are started sequentially. In particular, the tendency is remarkable in starting at low temperature. The increased power consumption during starting may lead to lower power efficiency.

The present specification provides a technology for suppressing an increase in power consumption during starting in a fuel cell system including a plurality of stacks.

The technology disclosed herein is embodied in a fuel cell system. This fuel cell system includes:
a first fuel cell stack;
a second fuel cell stack;
a first cooling system configured to cause a coolant to flow through the first fuel cell stack;
a second cooling system configured to cause the coolant to flow through the second fuel cell stack; and
a heat transfer system configured to allow or interrupt a flow of the coolant between the first cooling system and the second cooling system.

In the fuel cell system, when one fuel cell stack out of the first fuel cell stack and the second fuel cell stack, for example, the first fuel cell stack, performs power generation and the second fuel cell stack does not perform power generation during starting of the fuel cell system, the temperature of the first fuel cell stack is increased along with the power generation by the first fuel cell stack, and the temperature of the coolant flowing through the first cooling system is also increased. By causing the coolant to flow from the first cooling system to the second cooling system by the heat transfer system, the coolant flows through the second fuel cell stack and the temperature of the second fuel cell stack is increased. That is, heat generated in the first fuel cell stack via the heat transfer system is used in the second fuel cell stack. Therefore, the use of electric power from the battery or the first fuel cell stack is suppressed or avoided. As a result, power consumption for starting the power generation by the fuel cell stacks is suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an overview of a fuel cell system disclosed herein;

FIG. 2 is a flow chart of an exemplary process performed at the beginning of operation of a plurality of fuel cell stacks in a fuel cell system; and

FIG. 3 is a flowchart illustrating another example of a process executed at the start of operation of a plurality of fuel cell stacks in the fuel cell system.

### DETAILED DESCRIPTION OF EMBODIMENTS

One aspect of the fuel cell system disclosed herein includes:
a first fuel cell stack;
a second fuel cell stack,
a first cooling system for circulating a refrigerant to the first fuel cell stack,
a second cooling system for circulating the refrigerant to the second fuel cell stack,
a heat transfer system capable of circulating the refrigerant between the first cooling system and the second cooling system and blocking the refrigerant.

Another aspect of the fuel cell system includes:
further, a control device for controlling power generation of the first fuel cell stack and the second fuel cell stack.
   The control device may include performing: a first start process of performing a start operation for starting power generation by the first fuel cell stack and the second fuel cell stack;
a determination process of determining a fuel cell stack capable of generating electricity among the first fuel cell stack and the second fuel cell stack after the first start-up process;
a first power generation process of causing one fuel cell stack to perform the power generation and causing the other fuel cell stack not to perform the power generation, the one fuel cell stack being determined as being ready for the power generation out of the first fuel cell stack and the second fuel cell stack in the determination process; and
a temperature increasing process of increasing a temperature of the other fuel cell stack by supplying the coolant flowing through the one fuel cell stack to the other fuel cell stack via the heat transfer system.

By the first start process and the determination process, a fuel cell stack capable of generating electric power is determined, electric power is generated in one of the fuel cell stacks capable of generating electric power, and operation is waited in the other fuel cell stack that is not capable of operating. The temperature of the refrigerant is increased in one of the fuel cell stacks that has been generated, and the temperature of the other fuel cell stack is increased by the refrigerant that has been increased in temperature. For this reason, for example, when a fuel cell stack is started at a freezing point, a fuel cell stack capable of generating electricity can be selected to generate electricity, and then another fuel cell stack that cannot generate electricity due to freezing or the like can be heated and thawed. Therefore, it is possible to efficiently start the other fuel cell stack by suppressing power consumption.

In the embodiment described above,
the first cooling system comprises a first radiator, and
   The second cooling system comprises a second radiator.
   The first power generation process is a process of generating power in the one fuel cell stack in a state where the refrigerant does not flow through one of the radiators provided in the one fuel cell stack.
   The temperature increasing process may include a process of raising the temperature of the other fuel cell stack in a state where the refrigerant does not flow through the other radiator included in the other fuel cell stack.
   In this way, since the heat of the refrigerant is not taken away by the first and second radiators, the first and second fuel cell stacks are efficiently heated.

In the above aspect, the method may include performing a second start process of performing a start operation for starting power generation of the other fuel cell stack after the temperature raising process. In this way, power consumption can be suppressed and power generation of another fuel cell stack can be reliably started.

Another aspect of the fuel cell system includes:
further, a control device for controlling power generation of the first fuel cell stack and the second fuel cell stack.
   The control device may include performing: a first start process of performing a start operation for starting power generation of one of the first fuel cell stack and the second fuel cell stack, and
a temperature increasing process of increasing a temperature of the other fuel cell stack out of the first fuel cell stack and the second fuel cell stack by supplying the coolant flowing through the one fuel cell stack to the other fuel cell stack.
   By doing so, for example, even when the possibility of freezing the gas flow path is low, it is possible to reduce power consumption for starting the plurality of fuel cell stacks by raising the temperature.

In another aspect described above, the control device may execute a second start process of performing a start operation for starting power generation of the other fuel cell stack after the temperature raising process. In addition, in the above-described another aspect, the temperature raising process may be performed by limiting the use of the electric power supplied from the battery included in the fuel cell system to the other fuel cell stack.

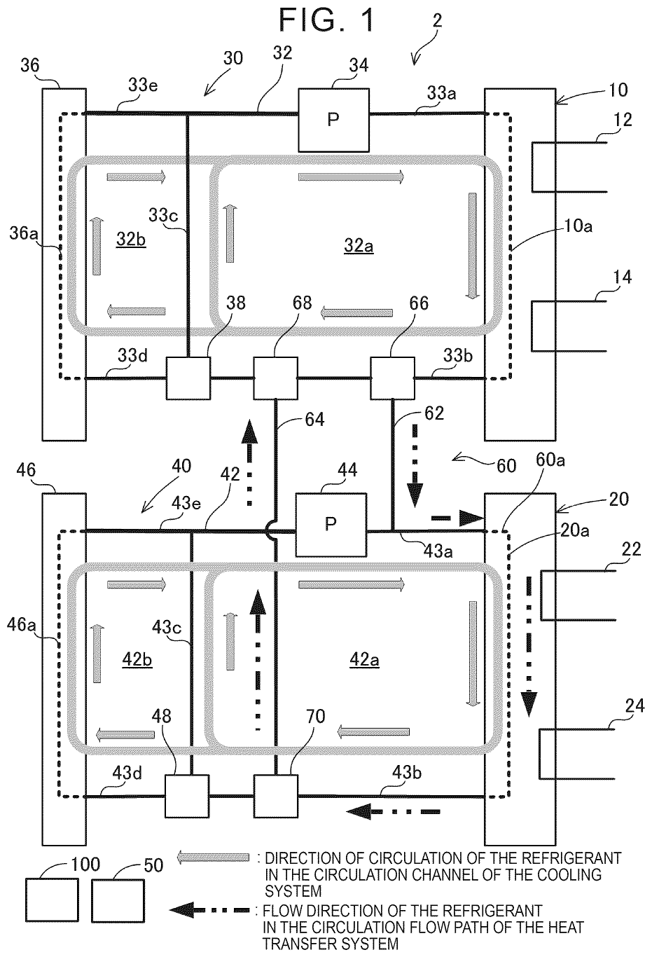

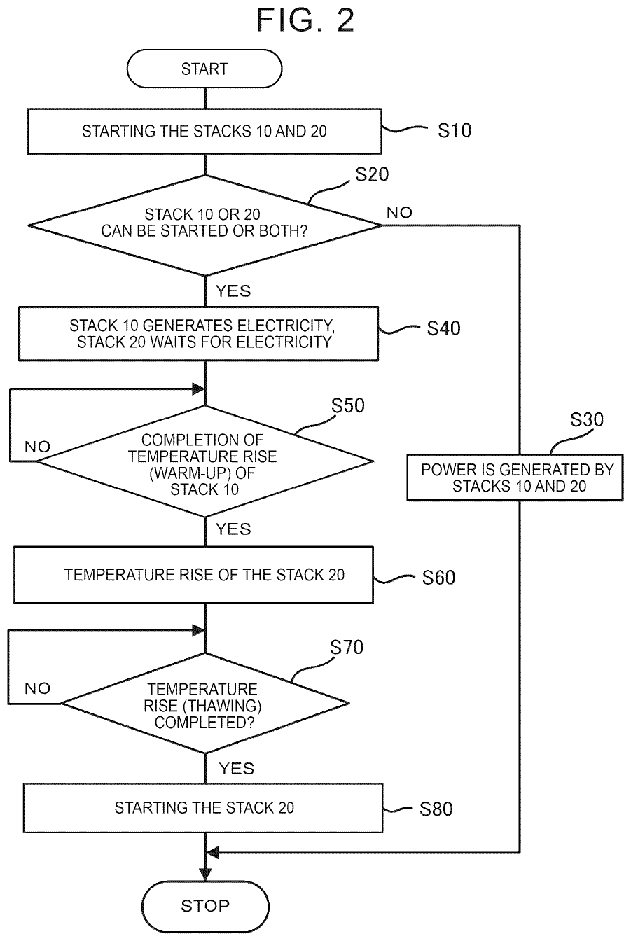

Hereinafter, a fuel cell system (hereinafter, also simply referred to as a system) 2 disclosed in the present specification will be described in detail with reference to the drawings as appropriate. FIG. 1 shows an outline of the system 2, and FIG. 2 shows a flowchart of a start-up process executed by the control device 100 included in the system 2.

The system 2 is not particularly limited, but may be, for example, a system applied as a driving power source of a moving body such as a vehicle or a stationary power generation facility. In addition, the type of the fuel cell in the system 2 is not particularly limited, but application to, for example, a polymer electrolyte fuel cell (PEFC) may be meaningful from the viewpoint of the operating temperature.

### Fuel Cell Stack

As illustrated in FIG. 1, the system 2 includes fuel cell stacks 10 and 20, cooling systems 30 and 40, a battery 50, a heat transfer system 60, and a control device 100. The number of stacks included in the system 2 is not limited to two, and is not particularly limited as long as it is a plurality of stacks, and is appropriately changed, as necessary.

Various sensors, valves, switches, and the like in the stacks 10 and 20, the fuel gas systems 12 and 22, the oxidant gas systems 14 and 24, and the cooling systems 30 and 40 are connected to the control device 100 so that signals can be input and output. The control device 100 is configured as a so-called computer. The control device 100 includes, for example, a processor and a memory, and is provided with an application necessary for controlling power generation including starting of the fuel cell stacks 10 and 20 of the system 2 so as to be executable.

The stacks 10 and 20 are formed by stacking known cells having a configuration corresponding to the type of the fuel cell. The stacks 10 and 20 are electrically connected to the battery 50 so that electric power supplied from the battery 50 can be used, and electric power generated by the stacks 10 and 20 can be supplied to the battery 50. Each of the stacks 10, 20 is an example of a first fuel cell stack and a second fuel cell stack disclosed herein.

### Fuel Gas System and Oxidant Gas System

Each of the stacks 10 and 20 includes fuel gas systems 12 and 22 through which fuel gas such as hydrogen is circulated, and oxidant gas systems 14 and 24 through which oxidant gas such as air is circulated. The fuel gas systems 12, 22 may be connected to the same fuel gas supply. Also, the oxidant gas systems 14, 24 may be connected to the same oxidant gas source.

### Cooling System

As shown in FIG. 1, the stacks 10 and 20 include cooling systems 30 and 40, respectively. The cooling systems 30 and 40 include pipelines 32 and 42 through which a predetermined refrigerant for cooling the stacks 10 and 20 flows, pumps 34 and 44 for circulating the refrigerant, and radiators 36 and 46, respectively. The pumps 34 and 44 and the radiators 36 and 46 may have any known configuration.

The cooling system 30 may form a circulation flow path 32a through which the coolant is circulated to the stack 10 by the pump 34 without passing through the radiator 36. The circulation flow path 32a includes a flow path 33a, a flow path 10a of the coolant in the stack 10, a flow path 33b, and a flow path 33c. The pump 34 is provided on the flow path 33a upstream of the stack 10 so as to flow the coolant toward the stack 10.

The cooling system 30 also forms a circulation flow path 32b for circulating the coolant through the radiator 36 to the stack 10. The circulation flow path 32b includes a flow path 33a, 10a, a flow path 33b, 33d, a flow path 36a of the coolant in the radiator 36, and a flow path 33e. The flow path 33d, 33e branches off from the circulation flow path 32a. A part where the flow path 33d branches from the circulation flow path 32a is provided with a valve 38 capable of forming the circulation flow path 32a and the circulation flow path 32b, respectively. The valve 38 is formed so as to be open in two directions so as to be able to configure a part of the circulation flow path 32a and to be open in two directions so as to be able to configure a part of the circulation flow path 32b.

The flow path 33b from which the coolant is discharged from the stack 10 is provided with valves 66 and 68. These valves 66 and 68 will be described later.

The cooling system 40 may form a circulation flow path 42a through which the coolant is circulated to the stack 20 by the pump 44 without passing through the radiator 46. The circulation flow path 42a includes a flow path 43a, a flow path 20a of the coolant in the stack 20, a flow path 43b, and a flow path 43c. The pump 44 is provided on the flow path 43a upstream of the stack 20 so as to flow the coolant toward the stack 20.

The cooling system 40 can also form a circulation flow path 42b that circulates the coolant through the radiator 46 to the stack 20. The circulation flow path 42b includes a flow path 43a, 20a, a flow path 43b, a flow path 46a of the coolant in the radiator 36, and a flow path 43e. The flow path 43d, 43e branches off from the circulation flow path 42a. A part where the flow path 43d branches from the circulation flow path 42a is provided with a valve 48 capable of forming the circulation flow path 42a and the circulation flow path 42b, respectively. The valve 48 is formed so as to be open in two directions so as to be able to configure a part of the circulation flow path 42a and to be open in two directions so as to be able to configure a part of the circulation flow path 42b.

Further, the flow path 43b through which the refrigerant is discharged from the stack 20 in the circulation flow path 42a is provided with a communication flow path 64 that branches toward the cooling system 30. A shut-off valve 70 is provided downstream of the communication flow path 64. The communication flow path 64 and the shut-off valve 70 will be described later.

### Heat Transfer System

The heat transfer system 60 is configured to form a circulation flow path 60a between the stacks 10 and 20, in other words, between the cooling system 30 and the cooling system 40 as needed. The circulation flow path 60a allows the refrigerant to flow therethrough and blocks the flow of the refrigerant. The heat transfer system 60 includes communication flow paths 62 and 64 that communicate with the cooling systems 30 and 40, flow paths 43a, 20a, 43b in the cooling system 40, valves 66 and 68, and a shut-off valve 70.

The communication flow path 62 is connected to the valve 66 in the cooling system 30, and is connected to the circulation flow path 42a downstream of the pump 44 and upstream of the stack 20 in the cooling system 40. The coolant flowing from the valve 66 through the communication flow path 62 is joined to the flow path 43a of the cooling system 40.

The communication flow path 64 is connected to the valve 68 on the flow path 33b in the cooling system 30, and is connected to the flow path 43b in the cooling system 40. The communication flow path 64 connects the coolant from the cooling system 40 to the circulation flow path 32a via the valve 66 without passing through the pump 44. The refrigerant flowing through the communication flow path 64 is joined to the circulation flow path 32a of the cooling system 30 via the valve 68.

The valve 66 is disposed on the flow path 33b and is formed so as to be open in two directions between the cooling system 30 and the valve 68 so as to form a part of the circulation flow path 32a. Further, the valve 66 is formed so as to be opened in two directions between the stack 10 and the communication flow path 62 so as to flow the refrigerant discharged from the stack 10 to the communication flow path 62.

The valve 68 is formed downstream of the valve 66 on the flow path 33c. The valve 68 is formed so as to be opened in two directions between the valve 66 and the valve 38 so as to form a part of the circulation flow path 32a. Further, the valve 68 is formed so as to be opened in two directions of the communication flow path 64 side and the valve 66 side so as to join the coolant supplied from the communication flow path 64 to the circulation flow path 42a.

The shut-off valve 70 is disposed on the flow path 43b and downstream of the branch to the communication flow path 64. The shut-off valve 70 is formed so as to be open in two directions between the flow path 43b and the valve 48 so as to form the circulation flow path 42a. The shut-off valve 70 is formed so as to block the refrigerant from the stack 20 from flowing into the valve 48 and flow into the communication flow path 64.

According to the heat transfer system 60, the flow of the refrigerant between the cooling system 30 and the cooling system 40 can be blocked by the opening and closing operations of the valves 66 and 68 and the shut-off valve 70. Further, according to the heat transfer system 60, the circulation flow path 60a through which the refrigerant flows between the cooling system 30 and the cooling system 40 can be newly formed by opening and closing the valves 66, 68, and 80 according to another aspect. In the circulation flow path 60a, the coolant flowing through the circulation flow path 32a by the pump 34 flows into the flow path 20a of the stack 20 via the valve 66, the communication flow path 62, and the flow path 43a. Further, the coolant discharged from the flow path 20a flows into the flow path 43b and the communication flow path 64, reaches the valve 68, and joins the circulation flow path 32a.

Next, a starting process executed when the control device 100 starts power generation at the time of starting the system 2 will be described. Note that the following process is mainly executed when the system 2 is in a low-temperature environment. In the cooling systems 30 and 40 of the stacks 10 and 20, the valves 38 and 48 are controlled so as to circulate the circulation flow path 32a, 42a which does not pass through the radiators 36 and 46, respectively. This is for promoting the temperature rise of the stacks 10 and 20 so that the refrigerant is not cooled by the radiators 36 and 46. The valves 66 and 68 and the shut-off valve 70 are controlled so that the coolant does not flow in the circulation flow path 60a of the heat transfer system 60.

The control device 100 performs an operation for starting power generation (S10) by supplying hydrogen/oxygen using electric power supplied from the battery 50 for both of the stacks 10 and 20. S10 for performing the start operation is an exemplary first start process in the present specification.

A determination is then made as to whether starting of the stack 10, 20 is allowed from the status of the stack 10, 20 (S20). The determination can be made based on, for example, the flow rate of hydrogen and the generated voltage when the supply of oxygen and hydrogen to the stacks 10 and 20 is started and power generation is attempted. For example, in a low-temperature environment under a freezing point, hydrogen may not flow due to freezing of hydrogen pipes, and the voltage may be reversed. When the control device 100 detects such a phenomenon, it is possible to determine a stack that cannot be started. When the outside air temperature is below the freezing point, it is difficult to determine which of the stacks 10 and 20 cannot be started by freezing, and therefore, the start process and the determination process are effective. S20 for performing the determination is an exemplary determination process disclosed in this specification.

In S20, if both of the stacks 10 and 20 can be started, the power generation is started as it is (S30), and the process is ended.

On the other hand, in S20, as an example, the stack 10 can be started, but when the stack 20 cannot be started, power generation is started for the stack 10, and the start operation is stopped for the stack 20 to wait for power generation (S40). The control device 100 stops the pump 44 and also closes the shut-off valve 70 in accordance with the stop of the starting operation of the stack 20, thereby stopping the flow of the coolant in the circulation flow path 42a. S40 for performing the power generation is an exemplary first power generation process disclosed herein.

When the power generation of the stack 10 starts, the temperature of the stack 10 is increased. By raising the temperature of the stack 10, the temperature of the refrigerant flowing through the stack 10 and the cooling system 30 is also raised. Note that the stack 10 may be heated by using the electric power supplied from the battery 50 so that the temperature rise is promoted.

Next, the control device 100 determines whether or not the temperature of the stack 10 has been sufficiently increased (for example, whether or not the warm-up operation has ended) (S50). The determination can be made, for example, based on the temperature of the stack 10 detected by the control device 100 or the refrigerant temperature flowing through the cooling system 30. Further, for example, the control device 100 can determine that the warm-up operation has ended when the temperature or the like of the stack 10 becomes equal to or higher than a preset threshold temperature. When the warm-up operation of the stack 10 is completed, the temperature of the refrigerant circulating in the circulation flow path 32a of the cooling system 30 in the stack 10 usually exceeds 0° C. While the warm-up operation of the stack 10 is not completed, the power generation (warm-up operation) of the stack 10 is continued. It should be noted that S50 may be replaced by continuously operating the stack 10 for a predetermined period of time.

When the control device 100 determines that the warm-up operation of the stack 10 has ended, the control device 100 raises the temperature of the stack 20 in which the start operation has been stopped (S60). By supplying the refrigerant circulating in the circulation flow path 32a of the cooling system 30 of the stack 10 to the cooling system 40 via the heat transfer system 60, the temperature of the stack 20 is raised. That is, the heat generated in the stack 10 is transferred and used for raising the temperature of the stack 20. In the temperature raising process of the stack 20, the fuel gas and the oxidant gas are not supplied. S60 of performing the temperature increase is an exemplary temperature increase process in the present specification.

The control device 100 opens the valves 66 and 68 toward the stack 20 to form the circulation flow path 60a of the heat transfer system 60. As the coolant passes through the flow path 20a of the stack 20, the frozen part of the stack 20 is warmed and thawed to allow gas-flow.

Next, the control device 100 detects, for example, the temperature of the stack 20 and the temperature of the coolant flowing through the stack 20, and determines whether or not the temperature of the stack 20 has been sufficiently increased (S70). The criterion for determining the temperature increase is, for example, a temperature at which the refrigerated portion of the stack 20 is defrosted and is estimated to be in a state in which power can be generated. When the temperature of the stack 10 exceeds a preset threshold temperature, for example, 0° C., the control device 100 determines that the frozen portion of the stack 20 has been thawed. The refrigerant flowing through the stack 10 is supplied to the stack 20 by the heat transfer system 60 until the thawing of the stack 20 is completed. S70 may be replaced by continuously flowing the coolant in the circulation flow path 60a for a predetermined period of time.

When the control device 100 determines that the decompression of the stack 20 is completed, the control device 100 starts supplying hydrogen and oxygen to the stack 20 and performs a start operation for generating electric power in the stack 20 again (S80), and ends the process. With the execution of the start operation, the control device 100 appropriately terminates the circulation of the refrigerant by the heat transfer system 60. To shut down the heat transfer system 60, the control device 100 operates the valves 66, 68 such that the coolant independently circulates through the circulation flow path 32a, 42a. S80 of performing the start operation again is another exemplary second start process disclosed herein.

Through the above process, for example, the stack 10 can be started, but when the stack 20 is frozen and cannot be started, the use of power for thawing the frozen portion of the stack 20 is suppressed or avoided. Power consumption during start-up of the system 2 is suppressed. As a result, even under the freezing point, the use of battery power is suppressed, and the plurality of stacks 10 and 20 can be started.

In the above-described embodiment, S60 for raising the temperature is performed until the frozen part of the stack 20 is thawed, but the present disclosure is not limited thereto. In the stack 20, the temperature increase may be performed until the normal warm-up operation is completed.

In the above-described embodiment, the heat transfer system 60 for supplying the refrigerant flowing through the stack 10 to the stack 20 has been described, but the circulation flow path of the heat transfer system for supplying the refrigerant flowing through the stack 20 to the stack 10 can also be constructed.

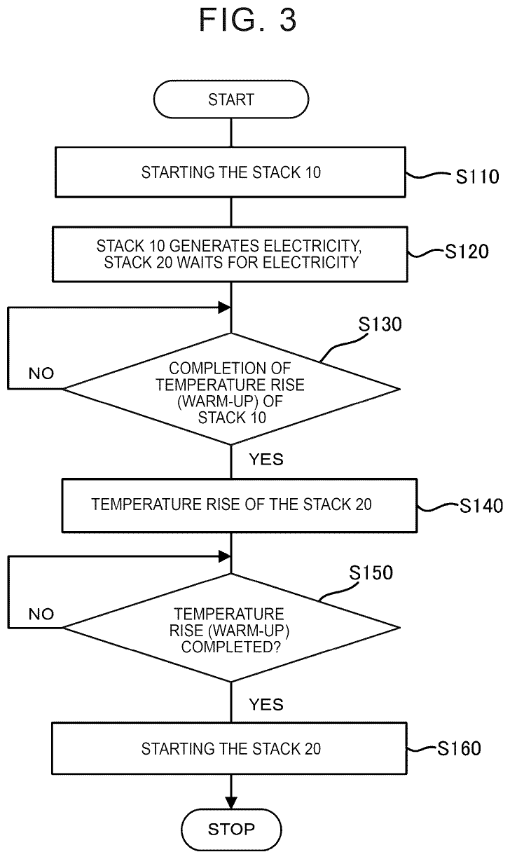

In the above-described embodiment, the control device 100 performs processing for determining the stack 20 that cannot be started, but the present disclosure is not limited thereto. For example, when the outside air temperature of the system 2 is such a temperature that freezing of the stacks 10 and 20 is not expected, only one of the plurality of stacks 10 and 20 may be started, and then the other stack may be heated and started. An example of such a startup process for stacks 10, 20 is shown in FIG. 3.

As shown in FIG. 3, the control device 100 first performs a S110 operation for starting the power generation of the stack 10. S110 of performing a start operation on the stack 10 is another exemplary first start-up process disclosed herein. The control device 100 performs power generation of the stack 10 without performing power generation for the stack 20 (S120). S120 of generating power of only the stack 10 is another example of the first power generation process disclosed in this specification.

Thereafter, the control device 100 determines whether the warm-up of the stack 10 is completed (S130). This S130 may be replaced by continuing the operation of the stack 10 for a predetermined period of time.

When it is determined that the warm-up operation of the stack 10 is completed, the control device 100 raises the temperature of the stack 20 (S140). The control device 100 operates the valves 66 and 68 and the shut-off valve 70 to form the circulation flow path 60a, and supplies the coolant of the cooling system 30 to the cooling system 40 to raise the temperature of the stack 20. S130 of raising the temperature of the stack 20 is another exemplary temperature raising process disclosed herein.

The control device 100 determines as to whether the temperature of the stack 20 has increased sufficiently (S150). The criterion here is, for example, whether or not the warm-up completion temperature obtained by the normal warm-up operation has been reached for the stack 20. This S150 may be replaced by continuously flowing the coolant in the circulation flow path 60a for a predetermined period of time.

When the control device 100 determines that the temperature of the stack 20 has reached the warm-up completion temperature, it performs an operation for starting the power generation of the stack 20 (S160) and ends the process. S150 for performing the starting operation of the stack 20 is another example of the second starting process in this specification.

By doing so, the warm-up operation can be performed only for the stack 10, and then the warm-up of the stack 20 can be completed without generating (operating) the stack 20 by using the heat from the stack 10. Even when the outside air temperature of the system 2 is such a temperature that the stacks 10 and 20 do not freeze, it is avoided that the warm-up operation is started simultaneously for each of the plurality of stacks 10 and 20, and the power consumption is suppressed, so that the electric power cost is expected to be improved.

Note that, in the process illustrated in FIG. 3, power supplied from the battery 50 may also be used for the warm-up operation of the stack 10. In this way, the warm-up operation of the stack 10 is completed at an early stage. When the temperature of the stack 20 is raised, the use of the electric power supplied from the battery 50 may be restricted (suppressed or not used). In this way, the power consumption is further suppressed.

While specific examples of the technology disclosed in the present specification have been described in detail above, these examples are merely illustrative and do not limit the scope of the claims. The technology described in the claims includes various modifications and variations of the specific examples described above, for example, a method of controlling a fuel cell. The technical elements described in this specification or in the drawings may be used alone or in various combinations, and are not limited to the combinations described in the claims at the time of filing. The technology illustrated in the present specification or the drawings can achieve a plurality of objects at the same time, and has technical usefulness in achieving one of the objects.

What is claimed is:

1. A fuel cell system comprising:
a first fuel cell stack;
a second fuel cell stack;
a first cooling system configured to cause a coolant to flow through the first fuel cell stack;
a second cooling system configured to cause the coolant to flow through the second fuel cell stack; and
a heat transfer system configured to allow or interrupt a flow of the coolant between the first cooling system and the second cooling system.

2. The fuel cell system according to claim 1, further comprising
a control device configured to control power generation by the first fuel cell stack and the second fuel cell stack, wherein the control device is configured to perform:
a first start process of performing a start operation for starting the power generation by the first fuel cell stack and the second fuel cell stack;
a determination process of determining a fuel cell stack ready for the power generation out of the first fuel cell stack and the second fuel cell stack after the start process;
a first power generation process of causing one fuel cell stack to perform the power generation and causing the other fuel cell stack not to perform the power generation, the one fuel cell stack being determined as being ready for the power generation out of the first fuel cell stack and the second fuel cell stack in the determination process; and
a temperature increasing process of increasing a temperature of the other fuel cell stack by supplying the coolant flowing through the one fuel cell stack to the other fuel cell stack via the heat transfer system.

3. The fuel cell system according to claim 2, wherein:
the first cooling system includes a first radiator;
the second cooling system includes a second radiator;
the first power generation process is a process of causing the one fuel cell stack to perform the power generation in a state in which the coolant does not flow through one radiator provided in the one fuel cell stack; and
the temperature increasing process is a process of increasing the temperature of the other fuel cell stack in a state in which the coolant does not flow through the other radiator provided in the other fuel cell stack.

4. The fuel cell system according to claim 2, wherein the control device is configured to perform a second start process of performing a start operation for starting the power generation by the other fuel cell stack after the temperature increasing process.

5. The fuel cell system according to claim 1, further comprising
a control device configured to control power generation by the first fuel cell stack and the second fuel cell stack, wherein the control device is configured to perform:
a first start process of performing a start operation for starting operation of one fuel cell stack out of the first fuel cell stack and the second fuel cell stack;
a first power generation process of causing the one fuel cell stack to perform the power generation and causing the other fuel cell stack not to perform the power generation; and
a temperature increasing process of increasing a temperature of the other fuel cell stack out of the first fuel cell stack and the second fuel cell stack by supplying the coolant flowing through the one fuel cell stack to the other fuel cell stack.

6. The fuel cell system according to claim 5, wherein the control device is configured to perform a second start process of performing a start operation for starting the power generation by the other fuel cell stack after the temperature increasing process.

7. The fuel cell system according to claim 5, wherein the temperature increasing process is performed on the other fuel cell stack by limiting use of electric power supplied from a battery provided in the fuel cell system.
